(19) United States
(12) Patent Application Publication
(10) Pub. No.: US 2005/0195778 A1
(43) Pub. Date: Sep. 8, 2005

(54) Method and device for setting up connections between communication terminals and data and/or communication networks having wireless transmission links, such as, for example, wireless local area networks (WLAN) and/or mobile telephone networks, and a corresponding computer program and a corresponding computer-readable storage medium

(76) Inventors: Magnus H. Bergs, Reykjavik (IS); Djamshid Tavangarian, Rostock (DE)

Correspondence Address: Norris, McLaughlin & Marcus P.A., 30th Floor, 220 East 42nd Street, New York, NY, 10017, US

(21) Appl. No.: 10/932,935

(22) Filed: Sep. 2, 2004

(30) Foreign Application Priority Data
Sep. 5, 2003 (DE) 103 41 873.3

(51) Int. Cl. H04Q 7/24; H04L 12/66

(52) U.S. Cl. 370/338; 370/352

(57) ABSTRACT

The invention relates to a method and a device for setting up connections between communication terminals and data and/or communication networks having wireless transmission links, for example, wireless local area networks (WLAN) and/or mobile telephone networks, and a corresponding computer program and a corresponding computer-readable storage medium, which can be used, in particular, to set up a secure access to WLAN networks. It is proposed to employ a device for setting up connections between communication terminals and data and/or communication networks having wireless transmission links, for example, wireless local area networks (WLAN) and/or mobile telephone networks, wherein the device includes a unit for setting up a connection with an integrated authentication and/or identification module, wherein the authentication and/or identification module is configured so that authentication and/or identification for access to the data and/or communication network via the authentication and/or identification module is performed independent of the operating system of the communication terminal.

The invention relates to a method and a device for setting up connections between communication terminals and data and/or communication networks having wireless transmission links, for example, wireless local area networks (WLAN) and/or mobile telephone networks, and a corresponding computer program and a corresponding computer-readable storage medium, which can be used, in particular, to set up a secure access to WLAN networks.

Presently, a large number of new hot spots are being established in both small and large WLAN networks. These are offered by different providers, each having their own access and billing methods. So far, no solutions exist that, on one hand, allow secure access control and billing and, on the other hand, can be easily managed by a user and enable transparent use of the infrastructure. Current GSM networks achieve these properties by using a SIM-card. However, these possibilities do not yet exist for WLAN networks.

Currently, different methods exist for authentication and/or identification according to IEEE 802.1X (EAP/TLS, LEAP, PEAP). These methods are supported by many publicly accessible WLAN access points, with different variants offered by different manufacturers. In present systems, clients are primarily authenticated by software. This functionality can be part of the operating system or can be performed by additional software, for example, by software provided by the manufacturer of the WLAN hardware.

Using an authentication system requires that all components are matched (RADIUS server [RADIUS=Remote Authentication Dial In User Service], Access Point, WLAN hardware, operating system, authentication software). These complex interdependencies between the components, in particular between the clients, are a major reason for the rather limited use.

A significant disadvantage of the authentication via software is that this process can be easily attacked. A secret key or a password must be stored at the client. The secret information can in principle be relatively easily accessed by manipulating the system, for example by Trojan horses.

In the context of further developing the actual WLAN technique, several efforts have been made to increase security. The focus here is the security of data transmission via the air interface. The future standard IEEE 802.11i (expected for 2004) should be mentioned here as an essential center of attention. When the standard is ratified, the standard can be expected to be integrated into every new product and many existing devices can be expected to be retrofitted by firmware upgrades.

The standard 802.1X exists for authentication. It requires support at the WLAN access point, which is the case with many commercially available products from various manufacturers. In all known applications, the functionality is implemented at the client in software, which entails the aforementioned disadvantages. Another variant is authentication via smartcard. The actual authentication is here performed within a smartcard, whereby the secret information does not have to leave the smartcard. Interaction between the WLAN card arid the smartcard is mediated by the operating system. This function is integrated, for example, in Windows XP. A major disadvantage of this variant is the additionally required smartcard reader. In particular, smartcards can frequently not be used at all or only in a limited, impractical way with small mobile devices, for example PDAs.

A generic WLAN architecture is disclosed in the German published patent application DE 100 43 203 A1, which discloses a method and a system for using several networks of different types, for example the use of data networks (WLAN) by logging in via a cellular mobile telephone network (GSM), whereby one of the networks generically provides logical functions of components of the respective other network.

The international patent application WO 03/032618 A1 “Integration of Billing between Cellular and WLAN Networks” describes integration of a billing system between cellular and WLAN networks. This solution enables mobile telephones (GSM/GPRS) to log into data networks (LAN) via cellular networks. A (temporary) account is established in the data network, which determines the charges and subsequently transmits the charges to the billing system of the cellular network. However, this solution does not enable movement between log-in points of different providers of the cellular networks while using the networks.

The German published patent application DE 101 52 572 A1 titled “Method and device for authenticated access of a station to local data networks, in particular wireless data networks” describes a method and a corresponding device which enable authentication in the wireless data network by transmitting to a user access information for accessing the wireless data network via a telecommunication network that is separate from the wireless data network, in particular by way of SMS (=Short Message System) via a mobile telephone network.

The German published patent application DE 101 37 551 A1 titled “Prepaid use of special service offers” proposes a system, whereby services of a server located in a telecommunication network can be used, after a user account and a user credit balance have been established on the server. In particular, a prepaid method is used.

The European patent application EP 0 970 411 B1 titled “Data copy protection” discloses a method for protecting data transmitted via a network. Copyrighted parts of HTML pages are treated separately to prevent unauthorized use.

It is therefore an object of the invention to provide a method and a device for setting up connections between communication terminals and data and/or communication networks having wireless transmission links, such as, for example, wireless local area networks (WLAN) and/or mobile telephone networks, and a corresponding computer program and a corresponding computer-readable storage medium, which obviate the aforementioned disadvantages and, more particularly, prevent third parties from interfering with the authentication and/or identification process.

This object is solved by the invention by the features recited in claims 1, 14, 15, 27, and 28. Advantageous embodiments of the invention are recited in the dependent claims.

According to a particular advantage of the method of the invention for setting up connections between communication terminals and data and/or communication networks having wireless transmission links, such as, for example, wireless local area networks (WLAN) and/or mobile telephone networks, storage of the data required for authentication and/or identification as well as the process of authentication and/or identification is performed without intervention by the operating system of the communication terminal, because links are established by a unit for setting up connections having an integrated authentication and/or identification module, wherein the authentication and/or identification for access to the data and/or communication network is performed by the authentication and/or identification module independent of the operating system of the communication terminal.

A device according to the invention is advantageously configured so that the device includes a unit for setting up a connection with an integrated authentication and/or identification module, wherein the authentication and/or identification module is configured so that authentication and/or identification for access to the data and/or communication network via the authentication and/or identification module is performed independent of the operating system of the communication terminal.

Another device for setting up connections between communication terminals and data and/or communication networks having wireless transmission links, such as, for example, wireless local area networks (WLAN) and/or mobile telephone networks is characterized in that the device includes a VoIP-module in addition to a unit for setting up the connection, wherein the VoIP-module can be used independent of the communication terminal.

The computer program according to the invention for setting up connections between communication terminals and data and/or communication networks having wireless transmission links, such as, for example, wireless local area networks (WLAN) and/or mobile telephone networks, enables a computer, after the computer program is loaded into the memory of the computer, to execute a process for setting up connections in such a way that links are established by a unit for setting up connections with an integrated authentication and/or identification module, wherein the authentication and/or identification for access to the data and/or communication network is performed by the authentication and/or identification module independent of the operating system of the communication terminal. Such computer program can be implemented, for example, as firmware of the device of the invention.

For example, these computer programs can be provided for downloading in a data or communication network (either with or without a fee, or freely accessible or protected by a password). The computer programs provided in this way can be used by a method, wherein a computer program according to claim 27 is downloaded from an electronic data network, for example from the Internet, to a data processing device connected to the data network.

For certain applications, a computer-readable storage medium can advantageously be employed, which stores a program that enables a computer, after the program is loaded into the memory of the computer, to perform a process for setting up connections between communication terminals and data and/or communication networks having wireless transmission links, such as, for example, wireless local area networks (WLAN) and/or mobile telephone networks, in such a way that links are established by a unit for setting up connections having an integrated authentication and/or identification module, wherein the authentication and/or identification for access to the data and/or communication network is performed by the authentication and/or identification module independent of the operating system of the communication terminal. Such computer program can be implemented, for example, as firmware of the device of the invention.

According to advantageous embodiment of the method of the invention, a WLAN interface card with inherent smartcard functionality is used for setting up the connection.

According to another preferred embodiment of the method of the invention, secret information, such as for example private keys, does not leave the secure memory region of the authentication and/or identification module. This makes it more difficult to spy out confidential data, such as for example a private key. Security can be further enhanced if the secret information is rendered useless in the event of an unauthorized access to the authentication and/or identification module.

Advantageously, at least a portion of the EAPOL packets is filtered from the received the data and processed by the authentication and/or identification module.

According to another advantageous embodiment of the method of the invention, authentication according to IEEE 802.1X with EAP/TLS is used and/or cryptographic methods are employed, accompanied by transmission of certificates.

In addition to a module for setting up connections, the device of the invention can provide additional useful functionalities. For example, advantageously, the unit for setting up a connection includes a module for packet-oriented voice services, for example telephony via Voice-over-IP (VoIP), whereby the module for packet-oriented voice services operates independent of the operating system of the communication terminal.

Advantageously, for stand-alone use of modules implemented on the device of the invention, the device can be configured so that power is supplied to the device by the power supply device for the communication terminal.

The authentication and/or identification module can typically store the security-related data in a secure memory region. Because a user may frequently already have other authentication and/or identification data, it can be advantageous to use these data for authentication and/or identification for-setting up connections between communication terminals and data and/or communication networks having wireless transmission links, such as, for example, wireless local area networks (WLAN) and/or mobile telephone networks. For this purpose, for authentication and/or identification by the authentication and/or identification module, data are exchanged with a SIM-card, and the authentication is performed with data stored on the SIM-card. The SIM-card can be viewed as being part of the authentication and/or identification module. Advantageously, an intelligent SIM-card or also a smartcard with additional information can be used in a protected memory region. In the following, exemplary embodiments will be described in more detail with reference to an (intelligent) SIM-card, wherein a smartcard can always be used instead of the (intelligent) SIM-card.

The (intelligent) SIM-card of the authentication and/or identification module can be installed in the same communication terminal as the unit for setting up the connection. In a particular embodiment, the (intelligent) SIM-card is installed directly on the unit for setting up the connection. In an alternative embodiment, the authentication and/or identification module includes several components, wherein the (intelligent) SIM-card is installed on a special, independent component, which is connected to the communication terminal by way of, for example, a dongle via a USB, a Bluetooth, an infrared or another type of interface. In other situations, the inherent WAN interface card can be installed together with a portion of the authentication and/or identification module in a first, communication terminal, and the (intelligent) SIM-card can be installed in a second communication terminal that is different from the first communication terminal. This may be advantageously, if an inherent WLAN interface card inserted in a notebook uses data from an (intelligent) SIM-card of a mobile telephone. In this case, the data are advantageously exchanged between the authentication and/or identification module and the SIM-card via an infrared or a Bluetooth interface, which are installed in most recent communication terminals. For this purpose, the device has an interface for data exchange with a SIM-card, wherein the interface is implemented as an infrared or a Bluetooth interface. It will be understood that other types of interfaces and/or protocols can also be used for data exchange.

According to a preferred embodiment of the device of the invention, the authentication and/or identification module is implemented as a hardware solution or as a firmware solution.

In a particular embodiment, the authentication and/or identification module is implemented as a FPGA component.

Advantageously, a device for setting up connections between communication terminals and data and/or communication networks having wireless transmission links, such as, for example, wireless local area networks (WLAN) and/or mobile telephone networks, includes in addition to an authentication and/or identification module a compression module, a GPS module, and/or a module for packet-based voice services, for example telephony over Voice-over-IP (VoIP). The device together with a module for packet-oriented voice services, for example telephony via Voice-over-IP (VoIP), has an interface that is suitable for a headset.

By integrating the smartcard functionality according to the invention with the WLAN card, secure authentication is achieved for a large number of devices without undue complexity. Optionally, this functionality can be provided as hardware-based or a firmware-based solution. This is similar to smartcard authentication in that the secret information, the private key, cannot exit the hardware module. The data to be signed are transmitted to the module, and the result is returned. Access to the hardware is restricted by suitable technical measures so that the protected information cannot be accessed without a disproportionate effort.

Implementation takes place, for example, by upgrading/extending the card-internal software (firmware). This can be done without requiring modification of the actual hardware. It would be sufficient to upgrade the existing firmware. Modification of the firmware could involve, for example, filtering all transmitted EAPOL (EAP over LAN) packets from the received data, processing the filtered data, and replying to the data. Suitable cryptographic functions would also be implemented.

The solution of the invention can be employed in all WLAN applications that require secure authentication and/or identification.

WLAN networks covering a large area require a plurality of access points. These WLAN hotspots are typically provided by different providers, which typically also employ different access methods. For commercial use, mechanisms for access control, access limitation, and billing are absolutely necessary. These require secure authentication and/or identification of the user. To get around this situation arising from the large number of access requirements stipulated by the different providers, a system architecture with a centralized support and service center (central service location for hotspots) is proposed that checks the access authorizations of the users with a specifically designed proxy (RADIUS-proxy) installed at the hotspot. The service center also bills the charges for the clients and the hotspots, and offers comprehensive support and service.

The access methods of the invention and the WLAN interface card of the invention can be advantageously employed in conjunction with this uniform structure. The uniform access is provided by the WLAN interface card according to the invention, wherein the WLAN interface card is combined with smartcard functionality in a single unit. Centralized checks can be performed using secret private keys to provide secure authenticated network access for a client. This concept offers the highest security, integrity and transparency of the system for the user for communicating and exchanging data over the Internet.

In this way, a system is generated which provides a complete infrastructure for large area public WLAN networks with horizontal handover, from secure authentication possibilities to providing individual, personalized services, user administration, and billing.

Secure authentication is achieved by integrating corresponding measures into the WLAN access hardware. For example, authentication according to IEEE 802.1X with EAP/TLS is used; moreover, cryptographic methods are used accompanied by transmission of certificates. The actual secret item, i.e. the key, never leaves the WLAN card. Accordingly, it is not easily possible to listen to or spy out a third-party key. The authentication processes are thus carried out without involvement of the operating system which, on one hand, does not add complexity for the user and, on the other hand, ensures significant independence from the underlying system.

An embodiment of the invention will now be described in more detail with reference to the drawings. It is shown in:

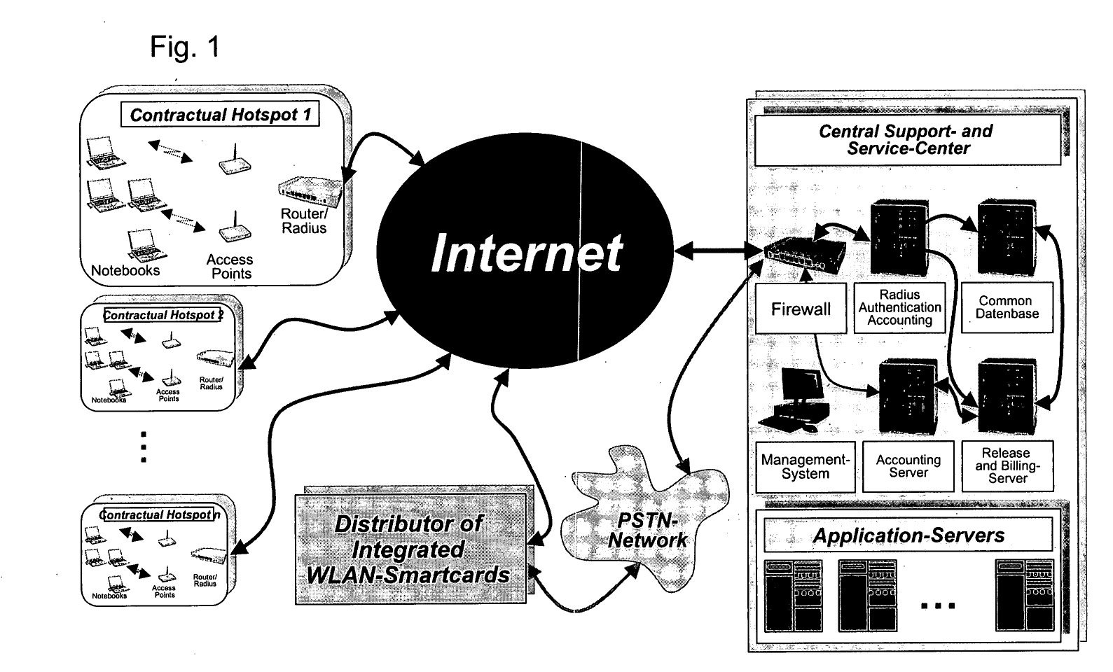

FIG. 1: a diagram of the WLAN system architecture when using a central centralized support and service center;

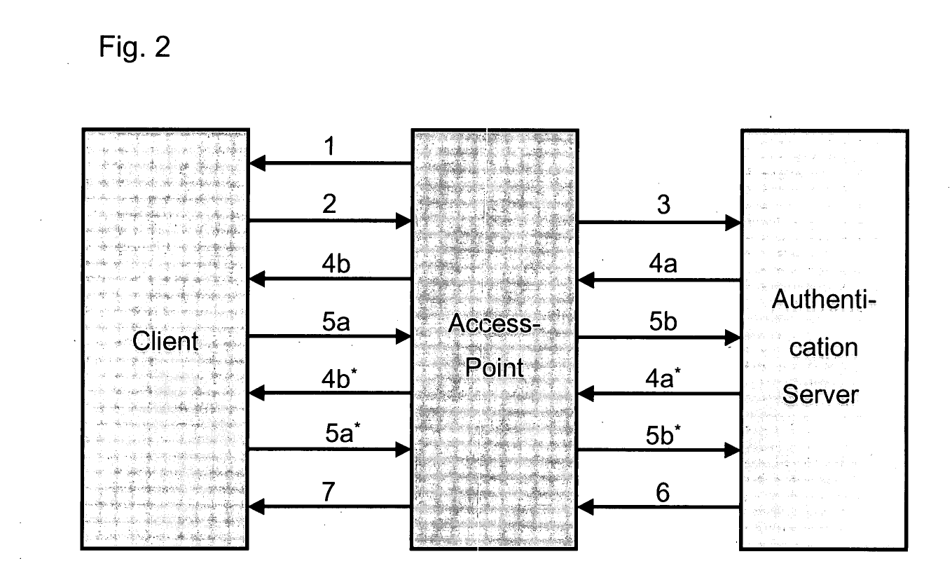

FIG. 2: a diagram of the communication processes executed during 802.1X authentication;

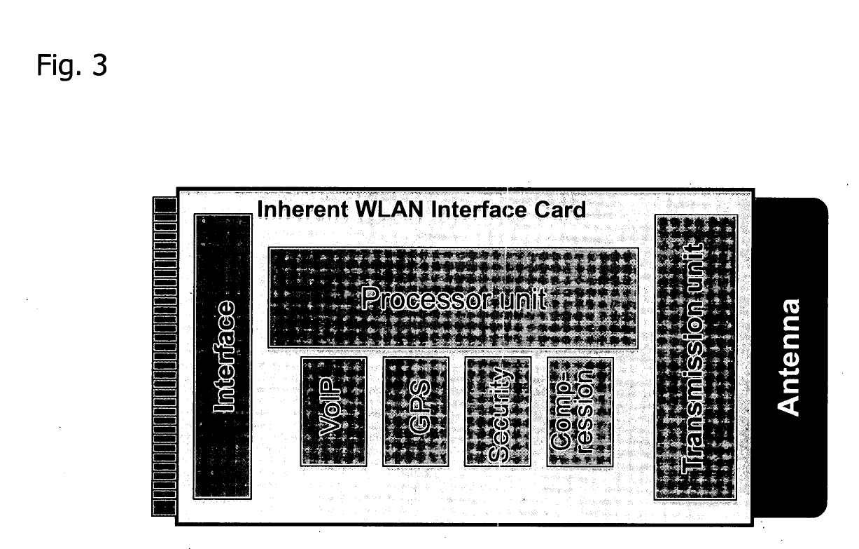

FIG. 3: a schematic diagram of an inherent WLAN interface card with enhanced functionality; and

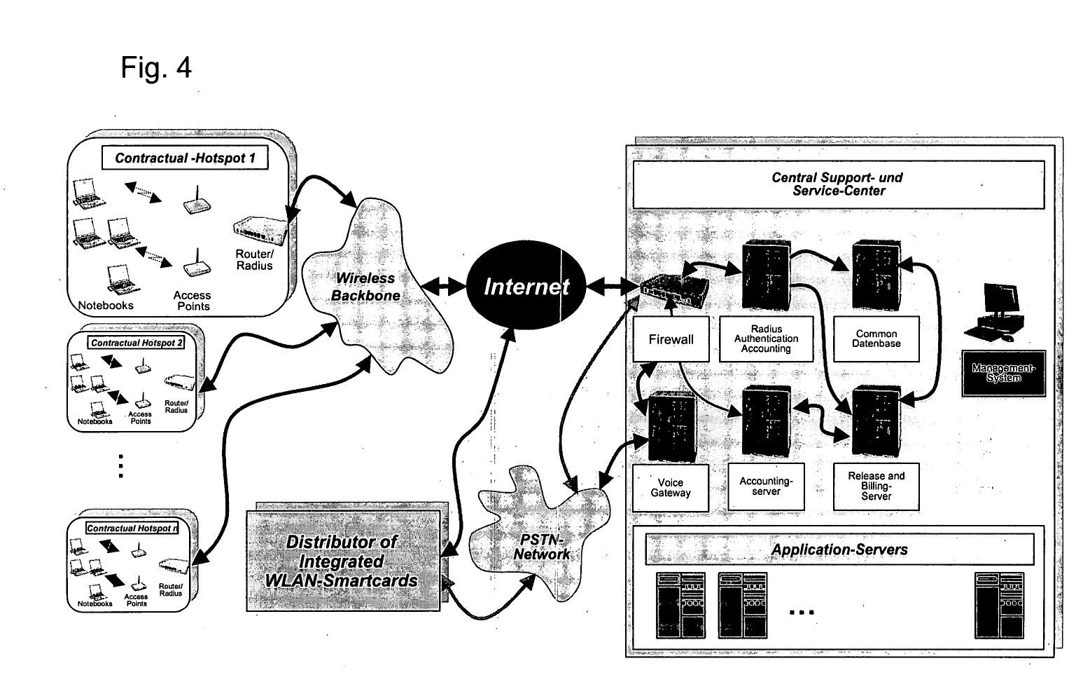

FIG. 4: a diagram of a system architecture enhanced by a voice gateway.

A WLAN network covering a large area requires a plurality of access points, so-called WLAN hotspots, which are generally offered by separate providers using different access methods. For commercial use, mechanisms for the access control, access restriction and billing are essential. These require a secure authentication and/or identification of the user. On this basis, it is possible to access a plurality of data (for example connection time, transfer volume) for billing purposes. However, the identification method must satisfy a number of important requirements:
Security: only an authenticated user should be able to use the Internet access and the offered services. Use of a false user identity should be almost entirely prevented. A user should be provided with the highest currently available data security.
Compatibility: the used authentication/identification method should be able to cooperate with a plurality of existing and future systems (hardware and software), without requiring adaptation for each individual situation.
Simplicity: setting up the network access and the identification/authentication mechanism should have minimal complexity. Moreover, extensive technical know-how should not be required.

The actual network access takes place via a large number of hotspots (see FIG. 1). These include one or more access-points (AP) for a WLAN connection, a router for Internet access, and optionally additional components for local data acquisition, services, etc. Moreover, the following discussion is based on the above mentioned system architecture with centralized support and service center (central service location for hotspots), which checks the access authorizations of the users with a proxy (RADIUS-proxy), which is specifically designed and installed at the hotspot, which assumes billing of charges for the clients and for the hotspots, and which offers comprehensive support and services. Authentication is checked centrally by an authentication server installed at the central support and service center.

Access is controlled by the access point according to the standard IEEE 802.1X (see FIG. 2). If a new client attempts to establish a connection, the AP requests identification 1 from the client. The client sends its identification to the AP 2, which is subsequently transmitted 3 from the AP to the authentication server. The authentication server can submit several queries 4 to the client and based on the responses, can either allow 5 network access or decline 6 network access. The access point enables 7 a connection from the client to the Internet only after receiving the access permission. The access information is transmitted in encrypted form to prevent manipulation of the access control.

The communication between the client and an access point takes place via the Extensible Authentication Protocol (EAP). Information is exchanged with the authentication server via the Internet through Remote Authentication Dial In User Service (RADIUS). The RADIUS server not only acquires access control data, but also connection data, which are transmitted from the access point also via RADIUS.

All required information is collected from the RADIUS-server in the central support and service center and stored in a central database. The database stores all information required for operating the system, including access data, billing information, management data, etc. Processing and billing is performed by a connected billing system. Various different billing models are possible based on the collected information (connection time, transfer volume, utilized services).

The WLAN interface card according to the invention includes a number of additional features in addition to modules for wireless communication according to the standards 802.11 b, g, a, and the like. In a particular embodiment, the interface card is implemented as an inherent WLAN interface card with integrated security functionality, a VoIP module for telephony with landline or mobile networks, a GPS module for determining position, and a compression module for compressing data using compression algorithms (see FIG. 3).

The Security Module provides secure data transmission during both authentication and the actual communication based on data encryption with public and private keys. This module is implemented, depending on the requirements, as a hardware solution or as a firmware solution. The hardware solution is implemented, for example, by a FPGA component. The FPGA component is programmed so that its functionality is destroyed in the event of an unauthorized access, so that the secret key cannot be retrieved. A software solution can also be considered as an extension of the firmware.

Different Compression Algorithms are known for optimizing data transmission. Data compression can sometimes significantly reduce the volume of the transmitted data and hence the transmission time. In the proposed system, the exemplary WLAN smartcard interface can be enhanced by a compression algorithm either as additional hardware or as the firmware within the control processor, so as to attain the aforementioned advantages. The hardware solution is characterized by high speed, resulting in a small latency. The compression algorithms involve lossless methods for recovering original data, whereas lossy methods are used with video and audio streams, because these are unaffected by loss of data in certain regions.

The compression module can be used particularly effectively in conjunction with a centralized support and service center, because significantly more efficient compression methods can here be used than in conventional networks, where only simple compression methods can be employed. Methods employing high compression could significantly increase the acceptance of a variety of content, such as video-on-demand and the like, because of the significantly shorter download times and the lower costs.

The GPS module is used for determining the location of a user, so that services with local context can be delivered to the user. In this case, the location of the device is determined with the module either periodically or occasionally, for example in response to a query, and transmitted to the central support center, where the required information can then be provided. This approach satisfies the requirements for “Local-Based-Support” that optimally support a user with respect to local service offers.

The VoIP-module is intended to provide, as the name implies, a packet-oriented voice service. A call is transmitted via the mobile terminal along the communication path between the terminal and the central support center, where a gateway is used to establish a connection to the PSTN or to a mobile provider. In the reverse direction, the received calls for the respective user can be connected in the same manner. Calls within the hotspots can be made according to established VoIP protocols, such as for example H323 and SIP. The calls can also be encrypted trough use of suitable security mechanisms.

In a particular embodiment, the VoIP connection can be set up and maintained exclusively via the VoIP module of the interface card, without using the processor and the operating system of the communication terminal. The interface card includes connections for a headset. The VoIP functionality is hence provided exclusively by the interface card, and the use of the VoIP functionality is therefore independent of installation of corresponding applications on the communication terminal.

In another potential application of a VoIP module, the VoIP module can be combined with a conventional WLAN interface card. In this way, a mobile WLAN-enabled VoIP telephone could be provided, which would also include an interface for additional communication terminals, for example notebooks or PDAs, and could therefore also be used as an interface card for these communication terminals to allow these communication terminals access to a WLAN network.

In a particular embodiment, the functionalities implemented on the WLAN interface card, such as the VoIP functionality, can be used in a stand-alone mode by supplying power to the interface card from the power supply unit of the communication terminal.

According to another embodiment, interfaces of the communication terminals are used for authentication. Most modern communication terminals, such as notebooks or PDAs, include wireless interfaces, for example infrared or radio-frequency interfaces (Bluetooth). User administration can be made more uniform by employing the security and/or identification functions provided by a SIM-card also for authentication when a user logs on, for example the Internet or, more particularly, a data or communication network having a system architecture with a centralized support and service center. The SIM-card would then not need to be located in the communication terminal, but could also be located in another device that is accessible via a corresponding interface, for example a Bluetooth-enabled mobile phone. To use the functions of the SIM-card, the security module integrated in the unit for setting up the connection establishes a connection to the SIM-card and exchanges the required information with a SIM-card and the authentication server in the communication network. The integrated security module thereby operates as a sort of intermediary. It should be mentioned, however, that authentication itself is performed by the security module, and not separately by the SIM-card. The SIM-card communicates in this process not with a network and, more particularly, not with the GPRS or GSM system, but instead, authentication is performed exclusively through the Internet provider with whom the user has signed a network access agreement, in particular for example via the authentication server of the centralized support and service center.

Likewise, the required connection between the device according to the invention for setting up a connection and the SIM-card can also be established in a different way, for example by an electric connection of the SIM-card with a socket intended for the WLAN interface card. This alternative embodiment is provided, for example, if the communication terminal itself has a SIM-card, as is the case, for example, with so-called smart phones, i.e., Internet-ready and multimedia-ready mobile telephones.

The scope of the invention is not limited to the aforedescribed preferred embodiments. Instead, a number of variations are possible which can include fundamentally different embodiments that are based on the system and methods according to the invention.

1. Method for setting up connections between communication terminals and data and/or communication networks having wireless transmission links, such as, for example, wireless local area networks (WLAN) and/or mobile telephone networks,
characterized in that
links are established by a unit for setting up connections having an integrated authentication and/or identification module, wherein the authentication and/or identification for access to the data and/or communication network is performed by the authentication and/or identification module independent of the operating system of the communication terminal.

2. (canceled)

3. Method according to one of the claim 1,
characterized in that
secret information such as, for example, private keys do not leave the secure memory region of the authentication and/or identification module.

4. Method according to claim 1,
characterized in that
at least a portion of the EAPOL packets is filtered from the received the data and processed by the authentication and/or identification module.

5. (canceled)

6. Method according to claim 1,
characterized in that
the secret information is rendered useless in the event of an unauthorized access to the authentication and/or identification module.

7. (canceled)

8. Method according to claim 1,
characterized in that
for authentication and/or identification by the authentication and/or identification module, data are exchanged with a SIM-card or a smartcard, and that the authentication is performed with data stored on the SIM-card or the smartcard.

9. (canceled)

10. (canceled)

11. Method according to claim 8,
characterized in that
the component having the SIM-card or the smartcard are connected with the communication terminal by way of a dongle.

12. Method according to claim 8,
characterized in that
a first component of the authentication and/or identification module together with the unit for setting up the connection are installed in a first communication terminal, and a second component of the authentication and/or identification module having the SIM-card or the smartcard are installed in a second communication terminal that is different from the first communication terminal.

13. (canceled)

14. Device for setting up connections between communication terminals and data and/or communication networks having wireless transmission links, such as, for example, wireless local area networks (WLAN) and/or mobile telephone networks,
characterized in that
the device comprises a unit for setting up a connection with an integrated authentication and/or identification module, wherein the authentication and/or identification module is configured so that authentication and/or identification for access to the data and/or communication network via the authentication and/or identification module is performed independent of the operating system of the communication terminal.

15. Device for setting up connections between communication terminals and data and/or communication networks having wireless transmission links, such as, for example, wireless local area networks (WLAN) and/or mobile telephone networks,
characterized in that
the device comprises a VoIP-module in addition to a unit for setting up the connection, wherein the VoIP-module can be used independent of the communication terminal.

16. Device according to claim 14,
characterized in that
the device is configured as a WLAN interface card with inherent smartcard functionality.

17. Device according to claim 16,
characterized in that
the authentication and/or identification module is implemented as a hardware solution or as a firmware solution.

18. Device according to claim 14,
characterized in that
a FPGA component is used for implementing the authentication and/or identification module.

19. Device according to claim 14,
characterized in that
the device comprises
a compression module,
a GPS module and/or
a module for packet-oriented voice services, for example telephony via Voice-over-IP (VOIP).

20. Device according to one of the claim 14,
characterized in that
the authentication and/or identification module comprises several components.

21. Device according to claim 20,
characterized in that
a component of the authentication and/or identification module is implemented as a dongle.

22. Device according to claim 20,
characterized in that
a component of the authentication and/or identification module comprises a SIM-card or a smartcard.

23. Device according to claim 14,
characterized in that
the device comprises an interface for data exchange with a SIM-card or a smartcard.

24. (canceled)

25. (canceled)

26. (canceled)

27. Computer program which enables a computer, after the computer program is loaded into the memory of the computer, to execute a process for setting up connections between communication terminals and data and/or communication networks having wireless transmission links, such as, for example, wireless local area networks (WLAN) and/or mobile telephone networks, in such a way that links are established by a unit for setting up connections with an integrated authentication and/or identification module, wherein the authentication and/or identification for access to the data and/or communication network is performed by the authentication and/or identification module independent of the operating system of the communication terminal.

28. Computer-readable storage medium which stores a program that enables a computer, after the program is loaded into the memory of the computer, to perform a process for setting up connections between communication terminals and data and/or communication networks having wireless transmission links, such as, for example, wireless local area networks (WLAN) and/or mobile telephone networks, in such a way that links are established by a unit for setting up connections having an integrated authentication and/or identification module, wherein the authentication and/or identification for access to the data and/or communication network is performed by the authentication and/or identification module independent of the operating system of the communication terminal.

29. Method, wherein a computer program according to claim 27 is downloaded from an electronic data network, for example from the Internet, to a data processing device connected to the data network.
